(19) United States
(12) Patent Application Publication
(10) Pub. No.: US 2001/0053286 A1
(43) Pub. Date: Dec. 20, 2001

(54) Method and apparatus for converting between color spaces in a digital film development system

(76) Inventors: Phillip E. Cannata, Austin, TX (US); David N. Jones, Austin, TX (US)

Correspondence Address: DINSMORE & SHOHL, LLP, 1900 CHEMED CENTER, 255 EAST FIFTH STREET, CINCINNATI, OH, 45202, US

(21) Appl. No.: 09/774,279

(22) Filed: Jan. 30, 2001

Related U.S. Application Data
(60) Provisional application No. 60/179,941, filed on Feb. 3, 2000.

(51) Int. Cl. G03B 17/24

(52) U.S. Cl. 396/310

(57) ABSTRACT

A system and method for converting from a digital film development system color space to a standard color space using a lookup table divided into a polyhedron. In one exemplary embodiment, back, front, and through image data is obtained from the digital film development system by recording light reflected from and transmitted through a developing film. For each pixel in the data, a lookup table is consulted to determine a mapping between the back, front, through data and standard color space values. The lookup table datapoints are divided into polyhedrons and it is determined which polyhedron matches the pixel. Then, from this polyhedron, a standard color space value can be interpolated, extrapolated, or otherwise calculated, or chosen directly from the table.

This application claims the benefit of U.S. Provisional Application No. 60/179,941 filed Feb. 3, 2000, the entire disclosure of which is hereby incorporated herein by reference.

### TECHNICAL FIELD

The present invention relates generally to digital film development systems, and more particularly to a digital film development system which includes a method and apparatus for converting from color spaces, such as for converting between a back-through-front color space to a device independent color space for instance.

### BACKGROUND OF THE INVENTION

Color photographic film generally comprises three layers of light sensitive material that are separately sensitive to red, green, and blue light. During conventional color photographic film development, the exposed film is chemically processed to produce dyes in the three layers with color densities directly proportional to the blue, green and red spectral exposures that were recorded on the film in response to the light reflecting from the photographed scene. Yellow dye is produced in the top layer, magenta dye in the middle layer, and cyan dye in the bottom layer, the combination of the produced dyes revealing the latent image. Once the film is developed, a separate printing process can be used to record photographic prints, using the developed film and photographic paper.

In contrast to conventional film development, digital film development systems, or digital film processing systems, have been developed. One such system involves chemically developing exposed film to form scene images comprised of silver metal particles or grains in each of the red, green, and blue recording layers of the film. Then, while the film is developing, it is scanned using electromagnetic radiation, such as light with one predominant frequency. For example, light having a predominant frequency in the infrared region could be utilized. In particular, as the film develops in response to chemical developer, a light source is directed to the front of the film, and a light source is directed to the back of the film. Grains of elemental silver developing in the top layer (e.g., the blue sensitive layer) are visible from the front of the film by light reflected from the front source; however, these grains are hidden from the back of the film. Similarly, grains of elemental silver developing in the bottom layer (e.g., the red sensitive layer) are visible from the back of the film by light reflected from the back source; however these grains are hidden from the front. Meanwhile, grains of elemental silver in the middle layer (e.g., the green sensitive layer) are hidden from the light reflected from the front or back; however, these grains are visible by any light transmitted through the three layers, as are those grains in the other two layers. Thus, by sensing, for each pixel location, light reflected from the front of the film, light reflected from the back of the film, and light transmitted through the film, three measurements can be acquired for each pixel.

Such scanning of each image on the film can occur at multiple times during the development of the film. Accordingly, features of the image which may appear quickly during development can be recorded, as well as features of the image which may not appear until later in the film development. The multiple digital image files for each image which are created by the multiple scannings can then be combined to form a single enhanced image file, which captures features of the image which appear during various development stages of the film. The enhanced image file is represented by an array of pixels, each pixel representing discrete locations in the source image, and each pixel having a back, through, and front color code value.

Once the image data is captured, the back, through, and front pixel color code values need to be converted or transformed into a usable form. For example, to view the image on a monitor, the data is usually required to be in an RGB color code format, and to print the image on an ink jet printer, the data is usually required to be in a CMY format.

When transforming the data from the pixel color code values to the device dependent color space, a colorimetric transformation and/or correction needs to be made to translate the data to a standardized color space (e.g., a device independent color space) which corresponds closely to the spectral sensitivities of the human eye and/or which is readily transferably to a color space to be used by the output devices. A standardized color space, such as the CIE XYZ color space, represents color images independent from particular devices so as to allow for conversion to any one of the desired output devices upon which the image is to be viewed.

A method and apparatus which can make such a colorimetric transformation and/or correction from back, through, and front values to standardized or device-dependent color values is desired. In addition, such a method and apparatus which can make such a transformation quickly, efficiently, and accurately is desired.

### SUMMARY OF THE INVENTION

According to one embodiment of the invention, a system for converting data between color spaces is provided. The system comprises a digital film development system adapted to create a set of back, through, and front digital values from an image developing on a film medium. The back value corresponds to radiation reflected from the back of the developing film medium, the through value corresponds to radiation transmitted through the developing film medium, and the front value corresponds to radiation reflected from the front of the developing film medium. The system also includes a memory unit storing a lookup table having datapoints correlating back, through, and front values to standard color space values. In addition, the system includes a color space conversion circuit in communication with the digital film development system and the memory unit. The color space conversion circuit is configured to receive the set of back, through, and front digital values, to match the set to a polyhedron formed from the datapoints in the lookup table, and to determine a set of standard color space values using the polyhedron.

It is an advantage of at least one embodiment of the present invention to accurately transform back, through, and front pixel data to a standardized color space.

An advantage of an embodiment of the present invention is to efficiently transform back, through, and front pixel data to a standardized color space.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which like reference numerals indicate corresponding structure throughout the figures.

FIG. 1 is a perspective view of an exemplary digital film development system having a color space conversion circuit and made according to principles of the present invention;

FIG. 2 illustrates an exemplary operation of the digital film development system of FIG. 1;

FIG. 3 is a schematic view of an exemplary digital film development system which utilizes multiple imaging stations to create multiple digital images of each frame of film at multiple film development times;

FIG. 4a is a flow diagram illustrating an exemplary method of generating a lookup table for use in converting pixel data from a digital film development color space to a standard color space, according to principles of the present invention;

FIG. 4b is a flow diagram illustrating an exemplary method of transforming pixel data from back, through, and front values to a standardized color space according to principles of the present invention;

FIG. 5 illustrates an exemplary three-dimensional array of back, through, front datapoints which can be constructed according to the present invention;

FIG. 6 illustrates an exemplary lookup table correlating back, through, and front datapoints of FIG. 5 to XYZ values;

FIG. 7a illustrates an exemplary division of the data of FIG. 5 into cubes and FIG. 7b illustrates the further division of each cube into prisms, according to one aspect of the present invention;

FIG. 8a and 8b illustrate an exemplary division of the data of FIG. 5 into tetrahedrons according to principles of the present invention;

FIG. 9a and 9b illustrate an alternative tetrahedral division of the data of FIG. 5 according to principles of the present invention;

FIG. 10 illustrates an alternative three-dimensional array of back, through, front datapoints which can be constructed according to the present invention;

FIGS. 11a and 11b illustrates an exemplary division of the data of FIG. 10 into tetrahedrons according to the present invention;

FIG. 12 illustrates an alternative tetrahedral division of the data of FIG. 5;

FIG. 13a is an exemplary flow diagram illustrating a method of generating a lookup table divided into polyhedrons for use in converting pixel data from a back, through, front color space to an XYZ color space, according to principles of the present invention;

FIG. 13b is an exemplary flow diagram illustrating a method of transforming pixel data from back, through, and front values to a XYZ values using the polyhedrons according to principles of the present invention;

FIG. 14 illustrates an exemplary mapping from a back, through, front color space to an XYZ color space according to principles of the present invention;

FIG. 15 is a block diagram showing an exemplary system for converting back, through, and front pixel data to XYZ data using a lookup table divided into polyhedrons; and

FIG. 16 illustrates an exemplary lookup table correlating polyhedrons to XYZ values.

### DETAILED DESCRIPTION OF EXEMPLARY EMBODIMENTS

In general, the present invention relates to a system and method for converting from a digital film development system color space to a standard color space using a lookup table divided into polyhedrons. In one exemplary embodiment, back, front, and through image data is obtained from the digital film development system by recording light reflected from and transmitted through a developing film. For each pixel in the image data, a lookup table is consulted to determine a mapping between the back, front, through values and standard color space values. The lookup table datapoints are divided into polyhedrons and it is determined which polyhedron matches the pixel. Then, from this polyhedron, a standard color space value can be interpolated, extrapolated, or otherwise calculated, or chosen directly from the table.

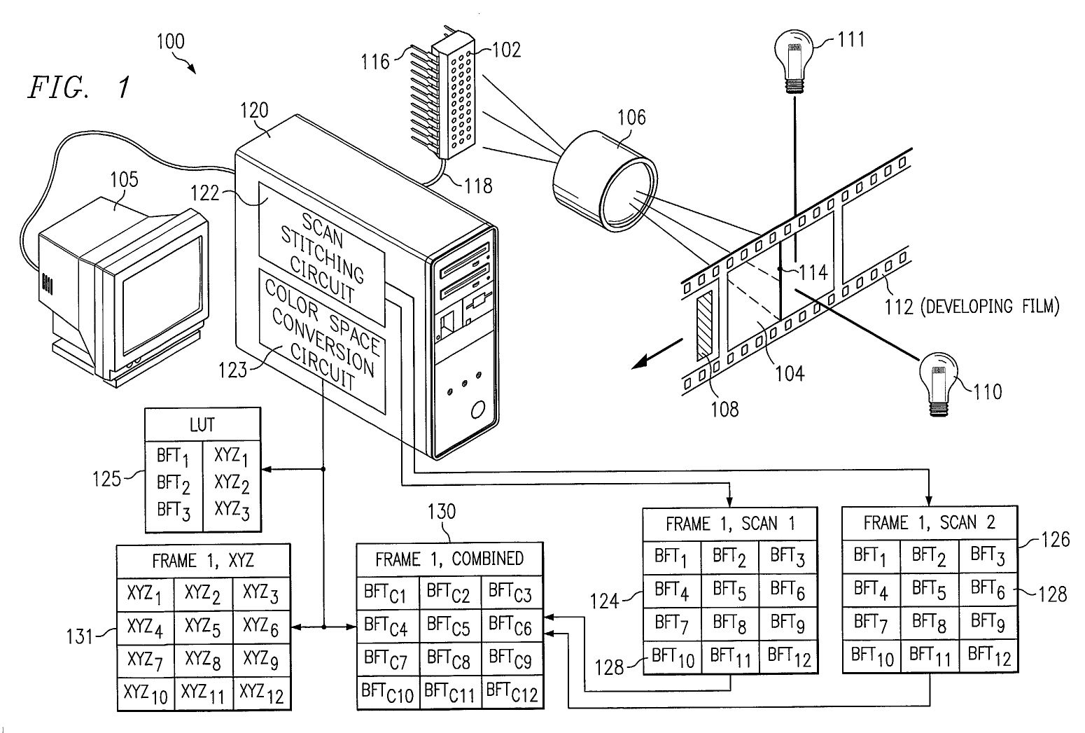

FIG. 1 shows an exemplary digital film developing system 100. The system operates by converting electromagnetic radiation from an image to an electronic (digital) representation of the image. The image being scanned is embodied in photographic film media 112 which is being developed using chemicals. In many applications, the electromagnetic radiation used to convert the image into a digital representation is infrared light; however, visible light, microwave and other suitable types of electromagnetic radiation may also be used to produce the digitized image. The scanning system 100 generally includes a number of optic sensors 102, which measure the intensity of electromagnetic energy passing through or reflected by the developing film 112. The source of electromagnetic energy is typically a light source 110 which illuminates the developing film 112 containing the scene image 104 and 108 to be scanned, which are forming on the film during the film development. Radiation from the source 110 may be diffused or directed by additional optics such as filters (not shown) and one or more lenses or waveguides 106 positioned between the sensor 102 and the developing film 112 in order to illuminate the images 104 and 108 more uniformly.

Furthermore, more than one source may be used. Source 110 is positioned on the side of the developing film 112 opposite the optic sensors 102. This placement results in sensors 102 detecting radiation emitted from source 110 as it passes through the images 104 and 108 on the film 112. Another radiation source 111 is shown placed on the same side of the film 112 as the sensors 102. When source 111 is activated, sensors 102 detect radiation reflected by the images 104 and 108. This duplex scanning process of using two sources positioned on opposite sides of the film being scanned is described in more detail below in conjunction with FIG. 2 The system 100 may be part of a larger optical and electronic system.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in a scanned image, or digital image file, which comprises a plurality of pixel data. The images 104 and 108 on film 112 can be sequentially moved, or scanned relative to the optical sensors 102. The optical sensors 102 are typically housed in a circuit package 116 which is electrically connected, such as by cable 118, to supporting electronics for storage and digital image processing, shown together as computer 120. Computer 120 can then process the digital image data and display it on output device 105. Alternatively, computer 120 can be replaced with a microprocessor or controller and cable 118 replaced with an electrical connection.

Optical sensors 102 may be manufactured from different materials and by different processes to detect electromagnetic radiation in varying parts and bandwidths of the electromagnetic spectrum. For instance, the optical sensor 102 can comprise a photodetector that produces an electrical signal proportional to the intensity of electromagnetic energy striking the photodetector. Accordingly, the photodetector measures the intensity of electromagnetic radiation attenuated by the images 104 and 108 on film 112.

Turning now to FIG. 2, a developing color film 220 is depicted. As previously described, the embodiments of the present invention described herein can use duplex film scanning which refers to using a front source 216 and a back source 218 to scan the developing film 220 with radiation 217 and 219. The applied radiation 217 and 219 results in reflected radiation 222 from the front 226 and reflected radiation 224 from the back 228 of the film 220, as well as transmitted radiation 230 and 240 that passes through all layers of the film 220. While the sources 216, 218 may emit a polychromatic light, i.e., multi-frequency light, the sources 216, 218 can be generally monochromatic, such as by emitting light having a predominant frequency in the infrared range for example. The resulting radiation 222, 224, 230, and 240 are referred to herein as front, back, front-through and back-through signals, respectively, and are further described below.

In FIG. 2, separate color layers are viewable within the film 220 during development of the red layer 242, green layer 244 and blue layer 246. More specifically, over a clear film base 232 are three layers 242, 244, 246 sensitive separately to red, green, and blue light, respectively. These layers are not physically the colors; rather, they are sensitive to these colors. In conventional color film development, the blue sensitive layer 246 would eventually develop a yellow dye, the green sensitive layer 244 a magenta dye, and the red sensitive layer 242 a cyan dye.

During chemical development of the film 220, such as by using a developer, layers 242, 244, and 246 are opalescent. Dark silver grains 234 developing in the top layer 246, (the blue source layer), are visible from the front 226 of the film by radiation 222, and slightly visible from the back 228 because of the bulk of the opalescent developer emulsion. Similarly, grains 236 in the bottom layer 242 (the red sensitive layer) are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the film 220 from both the front 226 and back 228 of the film, each pixel in the film 220 yields four measured values, the front, back, front-through, and back-through values.

The front signal records the radiation 222 reflected from the illumination sources 216 in front of the film 220. The set of front signals for an image is called the front channel (F). The front channel principally, but not entirely, records the attenuation in the radiation from the source 216 due to the silver metal particles or grains 234 in the top-most layer 246, which is the blue recording layer. There is also some attenuation of the front channel due to silver metal particles 236, 238 in the red and green layers 242, 244.

The back signal records the radiation 224 reflected from the illumination sources 218 in back of the film 220. The set of back signals for an image is called the back channel (B). The back channel principally, but not entirely, records the attenuation in the radiation from the source 218 due to the silver metal particles 236 in the bottom-most layer 242, which is the red recording layer. Additionally, there is some attenuation of the back channel due to silver metal particles 234, 238 in the blue and green layers 246, 244.

The front-through signal records the radiation 230 that is transmitted through the film 220 from the illumination source 218 in back of the film 220. The set of front-through signals for an image is called the front-through channel. Likewise, the back-through signal records the radiation 240 that is transmitted through the film 220 from the source 216 in front of the film 220. The set of back-through signals for an image is called the back-through channel. Both through channels (T) record essentially the same image information since they both record attenuation of the radiation 230, 240 due to the silver metal particles 234, 236, 238 in all three red, green, and blue recording layers 242, 244, 246 of the film 220. Accordingly, one of the through channel signals can be disregarded, if desired, or the two channels can otherwise be combined.

Several image processing steps can then be used to convert the illumination source radiation information for each channel (B, F, and T) to a device dependent color space, such as the red, green, blue values similar to those procured by conventional scanners for each spot on the film 220. These steps are used because the silver metal particles 234, 236, 238 that form during the development process are not spectrally unique in each of the film layers 242, 244, 246. These image processing steps are not performed when conventional scanners are used to scan film after it has been developed, because the dyes which are formed with conventional chemical color development of film make each film layer spectrally unique. However, just as with conventional scanners, once initial red, green, and blue values are derived for each image, further processing of the red, green, and blue values can be done to enhance and/or manipulate the image. As described in further detail below, one aspect of the present invention relates to transforming the B, F, and T data to a standard color space using geometrical interpretations of look-up tables.

The digital film development system shown in FIGS. 1 and 2 can produce multiple digital image files for the same image, each image file having the back, through, and front values according to the method described above. It is desirable to create multiple BTF image files for the same image at separate development times so that features of the image which appear at various development times are recorded. During the film development process, the highlight areas of the image (i.e., areas of the film which were exposed to the greatest intensity of light) will develop before those areas of the film which were exposed to a lower intensity of light (such as areas of the film corresponding to shadows in the original scene). Thus, a longer development time can allow shadows and other areas of the film which were exposed to a low intensity of light to be more fully developed, thereby providing more detail in these areas. However, a longer development time can also reduce details and other features of the highlight areas of the image. Thus, in conventional film development, the development time is typically chosen as a compromise between highlight details, shadow details and other features of the image which are dependent on the duration of development. However, in the digital film development process of FIGS. 1 and 2, such a compromise need not be made, as digital image files can be created at multiple development times.

In particular, as shown in FIG. 1, a pair of digital image files 124 and 126 can be created. The file 124 comprises a plurality of pixel values 128, each of which has B, F, and T values, representing attenuation by silver metal grains in the three film layers. Likewise, the file 126 comprises a plurality of pixel values 128 which represent attenuation by the silver grains. The digital image file 124 is created by scanning a frame (using source 110 and sensor 102) on the film 112 during a first film development time of the film, and the digital image file 126 is created by scanning the same frame during a second film development time. Once these files 124 and 126 are created, they can be combined or “stitched” into a single digital image file, which can include various features from both files, such as is described in U.S. Pat. No. 5,465,155, the entire disclosure of which is hereby incorporated herein by reference. As shown in FIG. 1, a stitching circuit 122 is provided as part of the image processing electronics 120 to combine the files 124 and 126 into a single enhanced image file 130.

Once the enhanced image file 130 is created, it can then be converted to values in a standard color space, such as the CIE XYZ color space, for example. Accordingly, a color space conversion circuit 123 is provided in the image processing electronics 120 to convert the combined B, F, and T values (indicated in FIG. 1 as BFT_{c}) for each pixel into X, Y, and Z values in the XYZ color space. As described in more detail below, the color space conversion circuit utilizes a lookup table 125 which correlates B, F, and T values to X, Y, and Z values. The lookup table can be established by using color patches, each patch having known or measurable XYZ values or some other color image having known or measurable XYZ values for the various colors on the image. These color patches or images can be exposed onto photographic film and scanned using the equipment of FIG. 1 to obtain B, F, and T values for each of the various colors shown. Each B, F, and T, value can then be matched in the lookup table 125 with the corresponding X, Y, and Z value.

The data in the table 125 can then be divided into polyhedrons. For those pixels in the file 130 which have BTF values not listed in the table 125, the circuit 123 can determine in which polyhedron the BTF values lie. Then, using this polyhedron, the circuit 123 can determine a corresponding XYZ value for the pixel. This process can be repeated on each pixel in the file 130 to arrive at a corresponding XYZ file 131.

The electronics 120 can be implemented using one or more controllers, processors, or logic circuits, and/or can be implemented in software using any of a variety of software development environments.

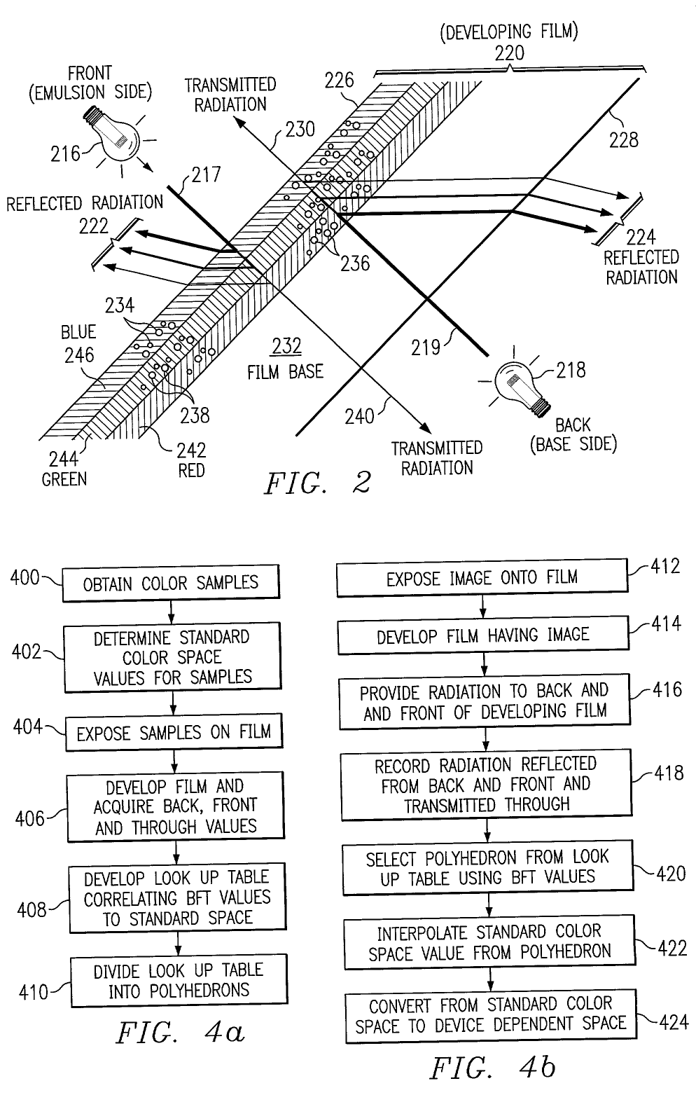

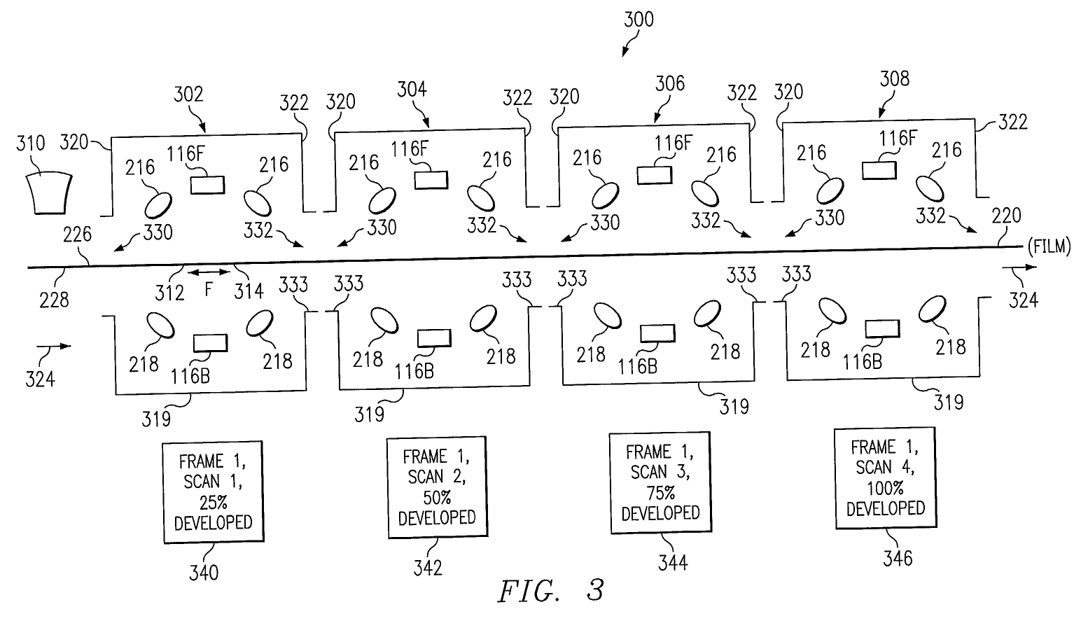

FIG. 3 shows an exemplary digital film development system 300 in which multiple scanning modules 302, 304, 306, and 308 are utilized to produce the multiple digital image files of the same image at different development times. Each module 302, 304, 306, and 308 in the digital processing system 300 includes a front source 216, a back source 218, a front sensor 116F, and a back sensor 116B, which operate as described above with respect to FIGS. 1 and 2. In particular, with reference to FIGS. 2 and 3, the front sensor 116F detects reflected radiation 222 (generated by front source 216), and also transmitted radiation 230 (generated by the back source 218). Likewise, the back sensor 116B detects the reflected radiation 224 (generated by back source 218), and the transmitted radiation 240 (generated by the front source 216).

Referring again to FIG. 3, the modules 302, 304, 306, and 308 are serially connected to form the system 300. Thus, the film travels in the direction 324 from the first module 302, to the second module 304, to the third module 306, to the fourth module 308. Finally, the film 220 exits from the system 300 via the film output side 322 of the fourth module 308.

The film 220 can be transported as a continuous strip through the modules 302, 304, 306, and 308 by a suitable film transportation or conveyance system. Because of the time lag between transportation of an image on the film 220 between the modules 302, 304, 306, and 308, each module scans and records a digital image file of a given frame at a different development time during the development of the film.

For example, each image or frame on the film, such as frame F which resides between the points 312 and 314, could have developer applied thereto, such as by dispenser 310. The transportation system would then move the frame F to module 302, where a first digital image file 340 is created, having two reflectance signals (a back reflectance signal and a front reflectance signal) and one transmission signal (a back-through signal or a front-through signal) as described above. The frame F would then be transported to module 304 where a second image file 342 is created of the same frame, again using two reflectance signals and one transmission signal. However, because of the predefined time lag in transporting the frame F from the first module 302 to the second module 304, the frame would be scanned by the second module 304 at a later point in the development of the image in the frame F. Thus, some features of the image which might be appearing within the frame F during the development of the film 220 might be captured in the first data image file 340, but not in the second data image file 342, and vice versa.

The additional modules 306 and 308 can be connected into the system 300 to provide additional image data files for the frame F at additional development times of the frame. For example, after the second image data file 342 is created for the frame F by the second module 304, a third image data file 344 could be created for the frame F at a later development time by the third module 306 which would obtain two reflectance signals and one transmission signal. Similarly, a fourth image data file 346 could be created by the fourth module 308 at the longest development time, also by obtaining two reflectance signals and one transmission signal. In this manner, four digital representations 340, 342, 344, and 346 of the same frame image may be obtained at different development times, such as at 25%, 50%, 75%, and 100% of the total development time, for example. These four digital representations 340, 342, 344, and 346 may then be combined with one another (i.e., stitched together) to form a composite digital representation of the image, which can then be converted to one or more other color spaces using geometric interpretation of lookup tables. The circuitry 120 of FIG. 1 can be utilized for this purpose, as can the exemplary methods and apparatus discussed below. Once the images have been combined and converted, the final digital representation may be viewed on a video monitor associated with a computer, or printed on a printer (such as a laser printer or an ink jet printer).

FIG. 4 is a flow diagram illustrating an exemplary color space conversion process for digital film development systems, which operates in accordance with principles of the present invention. In this example, FIG. 4a illustrates a process for developing a color space conversion lookup table, and FIG. 4b illustrates a process for utilizing the lookup table for converting between BTF values and standard color space values.

More specifically, at block 400 of FIG. 4a, color samples are obtained. The color samples can be evenly distributed over the entire output color gamut. In general, the greater number of samples chosen, the greater the accuracy. In this step, several color samples may be purchased or obtained or created and then combined to form additional color samples. For example, if four variations of cyan, four variations of magenta, and four variations of yellow are selected, then sixty-four (4×4×4) total color samples can be created.

Rather than creating or arranging color samples manually, any of a variety of suitable color collections or color images can be obtained during step 400. For example, a commercially available color collection or color image may be obtained. Color collections are typically divided into distinct color patches or color chips and are available from a number of sources. For instance, color collections sold under the MUNSELL® trademark by Gretag MacBeth could be utilized. The MUNSELL® Book of Color, Glossy Collection has 1564 color chips, while the MUNSELL® Book of Color, Matte Collection has 1270 color chips, and each provides the sets of standard tristimulus values corresponding to the included colors. Another example of such a color calibration collection is the Catalog Q60 color chart, which is available from Eastman Kodak and which corresponds to the IT8 color standard.

As noted, tristimulus values for a standard color space (e.g., the XYZ color space) are often provided for each of the colors shown on the color chart which is used. Alternatively, if tristimulus values from a standard color space are not available for the color samples utilized, such values can be measured for each of the colors which is chosen or created, as shown at block 402. For instance, a colorimeter, spectrophotometer, spectroradiometer, or other suitable color measuring equipment could be utilized. The data provided from such a calibration device can have three (i.e., tristimulus) values from a standard color space, such as the CIE XYZ color space, the CIE Luv colors space, or the CIE L*a*b* color space, for instance. Alternatively, the data provided by the device can be transformed to such a standard color space.

The color samples selected can then be exposed onto photographic film for calibration of a digital film development system, such as the systems of FIGS. 1-3. This step is shown as block 404 in FIG. 4a. Some commercially available color collections or charts may be provided on film already, and/or may have standard color space values for each of the patches or samples on the chart. Accordingly, steps 400 through 404 may be executed by simply obtaining such a commercially available color collection.

The film having the color samples thereon may then be developed and back, through, and front (BTF) values acquired for each of the samples using a digital film development system. This step is shown at block 406 of FIG. 4a. The systems described above with respect to FIGS. 1-3 could be utilized for obtaining BTF values for the samples. The values can be obtained at a normal development time of the film. However, separate sets of BTF values could be obtained for each color sample at separate film development times, and each set of BTF values stitched together for that color sample. Alternatively, separate BTF values can be acquired for separate film development times and the BTF data for each development time could be stored separately. Also, to increase accuracy, acquisition of BTF data for each development time of each color sample can be repeated or can be conducted by multiple sensors. This data can be mathematically combined, such as by averaging, to eliminate noise or variances in the sensors.

Upon completion of step 406, each of the color samples chosen will have at least one set of BTF values (the set being three separate values—a back value, a front value, and a through value) and a corresponding set of standard color space values (the set being three separate tristimulus values, such as X, Y, and Z values for example). If BTF data was taken for multiple development times, each color sample can have a separate set of BTF values for each film development time to be used in the digital film development system. Alternatively, the separate sets of BTF values for the various development times can be combined into one stitched BTF set to represent the various development times.

The BTF and standard values can then be used to populate one or more lookup tables (LUT) which correlate the back, through, and front values to the standard color space. For instance, each set of BTF values can be mapped to a corresponding set of tristimulus values in the standard color space, such as by using a three-dimensional lookup table.

Alternatively, predicted values can be derived for the various BTF values in the standard color space, such as by assuming that the back, through, and front signals correspond with the RGB color space and by using a suitable linear transformation between the RGB color space and the standard color space. For instance, if the XYZ color space is the standard color space being utilized, a known transformation between the RGB color space and the XYZ color space can be conducted, such as the following transformation:

$$[ \begin{matrix}X \\ Y \\ Z\end{matrix} ] = [ \begin{matrix}0.412453 & 0.357580 & 0.180423 \\ 0.212671 & 0.715160 & 0.072169 \\ 0.019334 & 0.119193 & 0.950227\end{matrix} ] \cdot [ \begin{matrix}R \\ G \\ B\end{matrix} ]$$

which can be found in “A Technical Introduction to Digital Video” by Charles A. Poynton. Once the standard color space values (e.g., XYZ values) are predicted for the set of BTF values of each patch in the standard color space, the difference between the predicted values and the actual values can be calculated for each color patch to derive color correction coefficients. Thus, the lookup table may directly map BTF values to standard color space values or can map BTF values to correction coefficients. In the former case, each color patch has a set of BTF values and a corresponding set of standard color space values, and in the latter case, each color patch has a set of BTF values (or predicted standard color space values) and a corresponding set of correction coefficients. The step of developing the lookup table is shown at block 408 of FIG. 4a. The values in the lookup table may be stored in one or more memory devices, such as a RAM, ROM, or other addressable memory device.

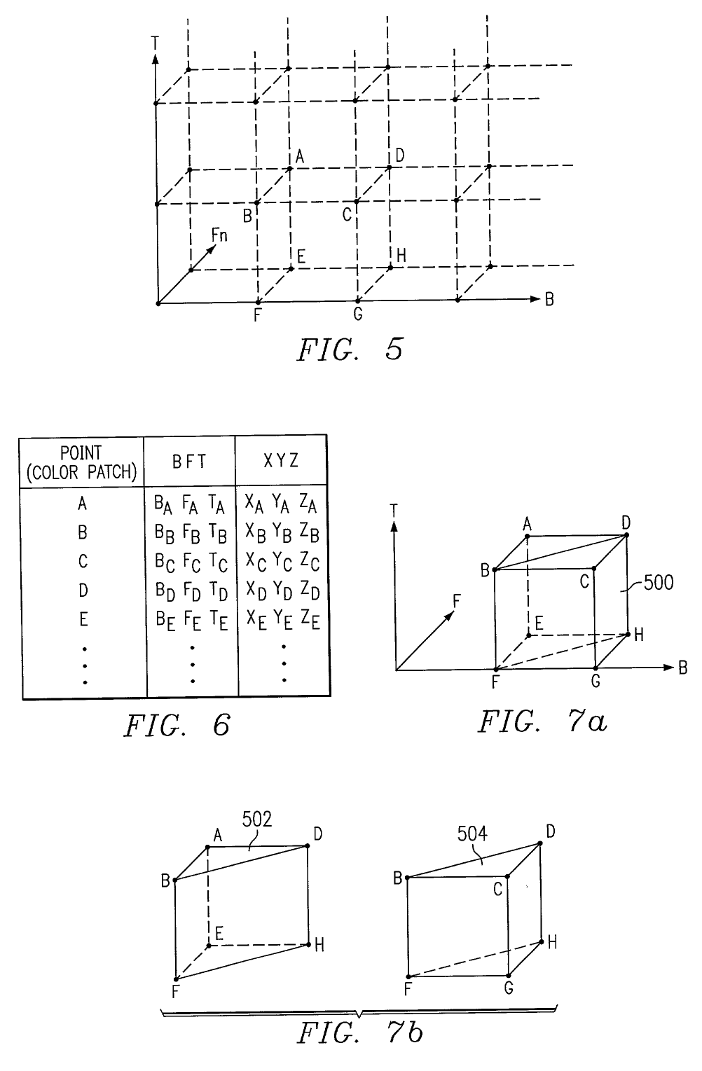

FIG. 5 and FIG. 10 illustrate three-dimensional back, through, front (BTF) spaces having a plurality of sample points. For instance, each sample point A, B, C, D, E, F, G, and H could have a set of BTF values from scanning one of the selected color samples using a digital film development system. Each of these points would also have a corresponding set of standard color space values, each set having at least one, but typically three values, such as XYZ values for example. The spacing between the points in either the BTF space or the standard color space may be uniform or non-uniform. The lookup table will match the BTF values for each point to corresponding standard color space values (or to coefficients which can be used to derive standard color space values.) FIG. 6 illustrates the configuration of such a lookup table, where the standard color space is the XYZ color space.

It may be desirable to increase the data points in the lookup table in order to increase accuracy. For example, it may be desirable to populate BTF-to-XYZ mappings between points A and B of FIG. 6. A number of methods can be utilized to further populate the lookup table. For example, any suitable linear or non-linear interpolation or extrapolation method can be used to increase the number of datapoints.

As another example, rather than imaging a large number of color samples or chips using the digital film development system, a relatively small number of color samples can be imaged, and the B, F, and T values of each recorded to derive a spectral sensitivity for the system. Each of these color samples also has a known spectral power density (SPD). From the derived spectral sensitivity and the known spectral power density, the values that the digital film development system would record for many other colors can be predicted to derive additional data for the lookup table.

For instance, the standard color space values (e.g., XYZ values) for other color patches can be used to synthesize spectral power densities for the other patches. The derived spectral sensitivity of the digital film development system and the synthesized spectral power densities for the other patches can then be used to predict system values (e.g., BTF values) for the other patches. Exemplary methods and algorithms for synthesizing such spectral power densities and predicting system values are described in co-pending U.S. patent application Ser. No. 60/172,528, entitled “Method and System for Color Calibration in an Imaging System” filed Dec. 17, 1999, the entire disclosure of which is incorporated herein by reference. As disclosed in this application, if the spectral sensitivity of the digital film development system and a synthesized SPD for a given color patch are in a discrete form, the respective matrices can be multiplied together to create device values, C_{ι}, as illustrated in the following equation, where R (a 3×j matrix) represents the spectral sensitivity of the imaging system and N_{ι}represents a synthesized SPD:

C_{ι}=RN_{ι};

where I=number of colors synthesized

Accordingly, with reference to FIG. 4a, the development of the lookup table in step 408 can be accomplished manually by scanning multiple color samples having known values in the standard color space and recording the BTF values and known standard color values for each sample. Alternatively, the step can be accomplished algorithmically by scanning a relatively few color samples and then deriving the data points for many other color samples of interest, thereby reducing the number of manual scannings which need to be conducted.

At step 410 of FIG. 4a, once the lookup table data has been established, the data can be divided into a number of polyhedrons to assist in future interpolations and extrapolations for future points measured by the digital film development system (but not having an exact match in the lookup table). In particular, the datapoints of the lookup table can be used to define vertices of polyhedrons, as shown in FIGS. 7, 8, 9, and 11. Any of a variety of polyhedrons could be utilized, such as regular polyhedrons, semi-regular polyhedrons, compound polyhedrons, pseudo polyhedrons, convex and non-convex polyhedrons, and uniform polyhedrons. In the example of FIG. 7a, the points A through H of the lookup table form a polyhedron having eight vertices and six faces. However, to reduce the complexity in interpolating a point using eight other points, the six-faced polyhedron 500 can be further divided into additional polyhedrons, as shown in FIG. 7b. In particular, each polyhedron 500 can be further divided into five-faced polyhedrons 502 and 504, each having six vertices.

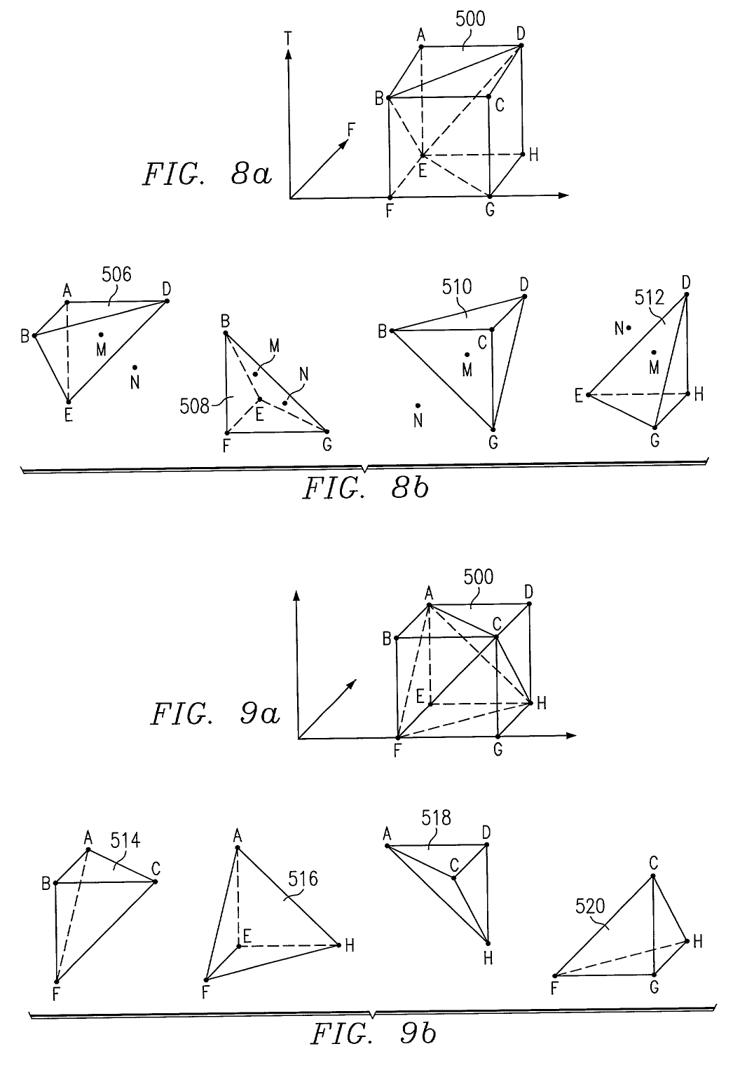

To further reduce the number of points that make up each polyhedron, tetrahedrons can be utilized. As shown in FIGS. 8a and 8b, each six-faced polyhedron 500 can be divided into four tetrahedrons 506, 508, 510, and 512. Each of the tetrahedrons has four vertices (from the datapoints of the lookup table) and has four faces, each face being a triangle formed from three of the vertices.

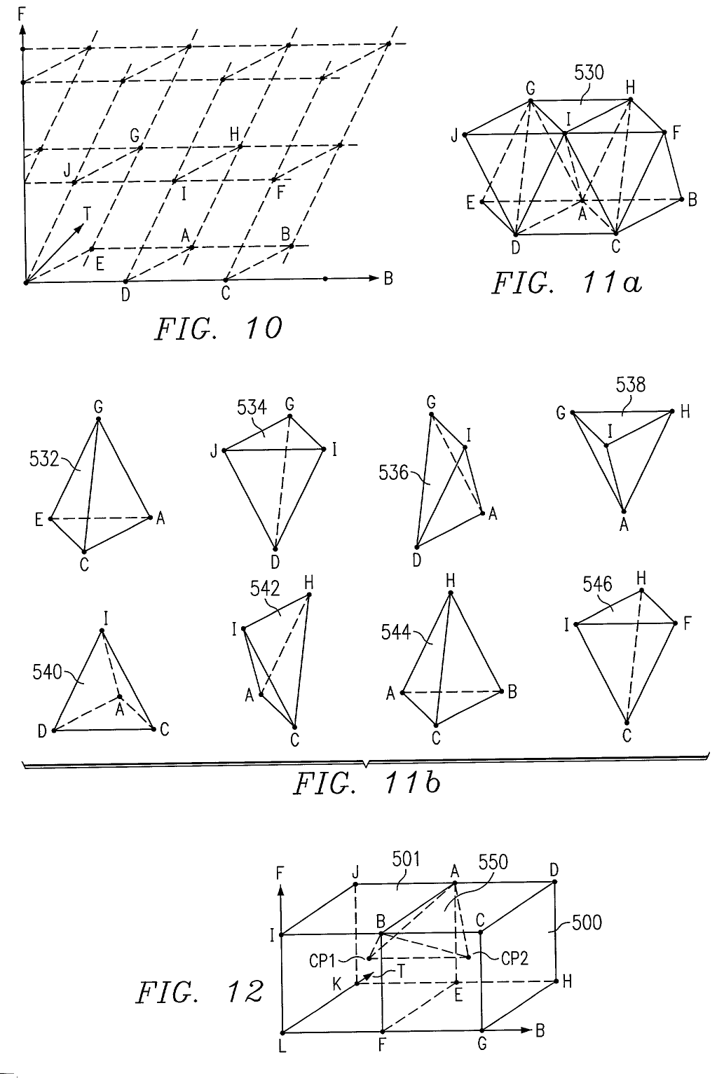

There are numerous ways in which tetrahedrons can be formed from the data in the lookup table. For instance, FIGS. 9A and 9B show how the same eight datapoints A through H can be utilized to form four different tetrahedrons (514, 516, 518, and 520) than the tetrahedrons formed in FIGS. 8a and 8b.

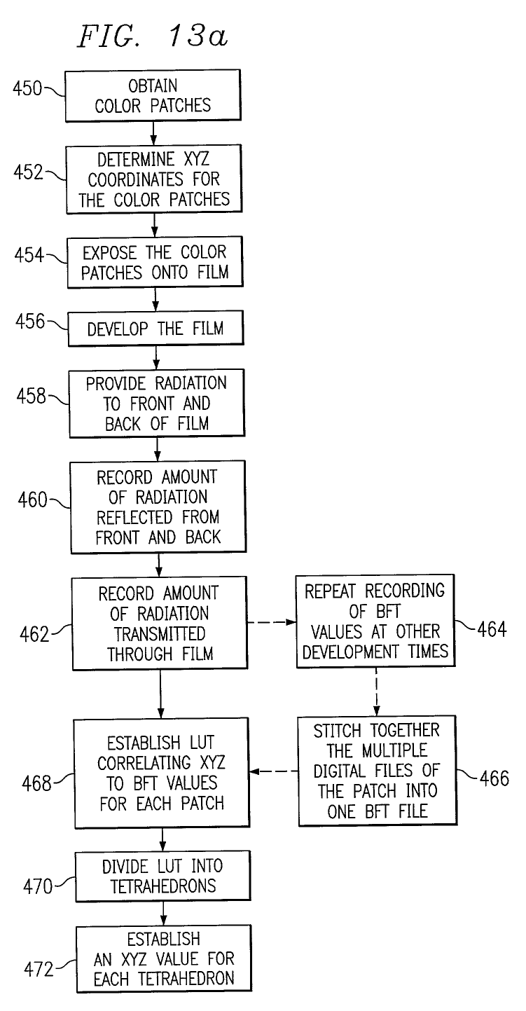

Thus, as can be understood, any of a variety of divisions of the lookup table data into polyhedrons can be utilized. Smaller and larger polyhedrons can be selected depending on the number of points utilized and the spacing of the points. Generally, smaller polyhedrons utilizing fewer vertices provide greater interpolation accuracy and efficiency. Additional exemplary polyhedron divisions and sub-divisions are shown in FIGS. 11 and 12. FIG. 11a shows the selection-of ten points from the non-uniform data of FIG. 10 for forming a polyhedron 530. This polyhedron 530 could be used directly in interpolating standard color space values for other measured data points. Alternatively, further divisions of the polyhedron 530 could be made, in order to simplify processing. For instance, as shown in FIG. 11b, the polyhedron 530 of FIG. 11a could be divided into eight tetrahedrons 532, 534, 536, 538, 540, 542, 544, and 546.

FIG. 12 shows an example where tetrahedrons can be formed from adjacent polyhedrons 500 and 501. In this example, the center points CP1 and CP2 of the polyhedrons 500 and 501 can be interpolated, calculated, or measured (by taking another data point). Then, tetrahedrons can be selected using the center points. For instance, the tetrahedron 550 can be formed by points A, B, CP1, and CP2, as shown in FIG. 12.

Once the lookup table has been established and polyhedrons selected therefrom, the data and polyhedrons can be used to transform and/or correct the BTF data which is acquired by a digital film development system. An exemplary method of transforming BTF data of a digital film development system to a standard color space is shown in FIG. 4b. At step 412, an image is exposed onto a film medium, such as by using a conventional photographic camera. The film is then developed at step 414 by using a chemical developer. During development of the film, radiation is applied to the back and the front of the film at different instances in time. These steps are shown at block 416. Radiation which is applied to the front of the film and reflected therefrom is then recorded, such as by using pixel sensors. Similarly radiation which is applied to the back of the film and reflected therefrom is also recorded. Also, radiation applied to the front and/or the back of the film and transmitted through the film to the other side is also recorded. The recordation of the back, through, and front signals is shown at block 418 of FIG. 4b. These three signals are recorded for each pixel of the image.

Once the image on the film is recorded in back, through, and front values for a plurality of pixels, this digital image data can then be converted to a standard color space using the lookup table which was developed by the method of FIG. 4a. More specifically, each pixel in the digital image data has back, through, and front values which need to be converted to standard color space values. To make such a conversion, a polyhedron can be selected from the lookup table which matches each pixel in the digital image data, as shown at step 420. To determine within which polyhedron the set of BTF values for a given pixel lies, a variety of mathematical methods could be utilized. In the example of FIG. 8b, the mean M of each of the tetrahedrons 506, 508, 510, and 512 could be determined by averaging the four vertices which make up each tetrahedron. To determine whether the new data point N lies in a particular tetrahedron, the direction of the mean point M with respect to each of the various faces of the particular tetrahedron are calculated. Also, the direction of the new data point N with respect to each of the various faces of the tetrahedron can be calculated. If the new point N has the same direction with respect to the four planes as the mean point M, then the new point N must reside within or on the tetrahedron, since none of the tetrahedrons overlap. This matching tetrahedron can then be used to determine the standard color space value which corresponds to the set of BTF values for the point N, as described in further detail below. As can be understood, other mathematical calculations or algorithms could be utilized for determining within which polyhedron a particular point N falls, such as by using ray crossings or barycentric coordinates for example.

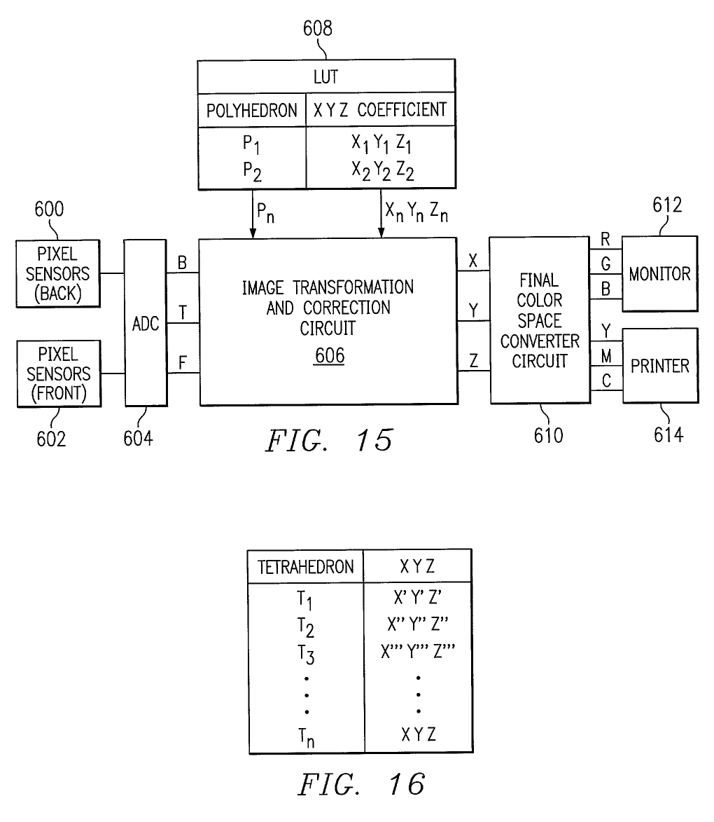

Once it is determined within which polyhedron the set of BTF values for a given pixel are located, the values for that pixel can then be converted to corresponding values in the standard color space. In particular, for each vertex of the polyhedron selected, the lookup table contains a set of BTF values and a set of standard color space values or coefficients (typically, but not necessarily, three values). The values for each of the vertices can then be used to determine a standard color space value or coefficient for the new points. A suitable interpolation equation or calculation can be used for this purpose. For example, FIG. 14 illustrates a point N having a set of BTF values (or values derived therefrom) in the BTF color space which falls within the polyhedron 570. To determine standard color space values/coefficients for a corresponding point N′ in the standard color space (e.g., XYZ space), a matrix interpolation equation could be utilized using the vertices A, B, C, and D in the lookup table, each vertex having a set of BTF space values and a set of corresponding XYZ space values. For example, the following matrix equation could be utilized:

$$\begin{matrix}[ \begin{matrix}X \\ Y \\ Z\end{matrix} ] = [ \begin{matrix}X2 - X1 & X3 - X1 & X4 - X1 \\ Y2 - Y1 & Y3 - Y1 & Y4 - Y1 \\ Z2 - Z1 & Z3 - Z1 & Z4 - X1\end{matrix} ] \cdot \\ {[ \begin{matrix}B2 - B1 & B3 - B1 & B4 - B1 \\ T2 - T1 & T3 - T1 & T4 - T1 \\ F2 - F1 & F3 - F1 & F4 - F1\end{matrix} ]}^{- 1} [ \begin{matrix}B - B1 \\ T - T1 \\ F - F1\end{matrix} ] + [ \begin{matrix}X1 \\ Y1 \\ Z1\end{matrix} ]\end{matrix}$$

Other interpolation algorithms and equations could also be utilized. For instance, when the data is divided into tetrahedrons having four vertices, triangular interpolation can be used in two dimensions and linear interpolation can be used in the third dimension. Other types of interpolation and/or estimation could be utilized, such as linear interpolation, bilinear interpolation, volumetric interpolation, non-linear interpolation, etc. Various interpolation methods and algorithms are described in “Interpolation and Approximation” by Phillip J. Davis (1963).

Returning again to FIG. 4b, for pixels having BTF values outside of the range of the lookup table, extrapolation techniques can be utilized during step 422. Linear extrapolation from the points or polyhedron nearest the measured set of BTF values can be utilized, as can other suitable linear or non-linear extrapolation techniques or algorithms. For instance, the following equation may be utilized, using the data points from the polyhedron in the lookup table nearest the newly measured set of BTF values:

$$\begin{matrix}[ \begin{matrix}X \\ Y \\ Z\end{matrix} ] = [ \begin{matrix}X2 - X1 & X3 - X1 & X4 - X1 \\ Y2 - Y1 & Y3 - Y1 & Y4 - Y1 \\ Z2 - Z1 & Z3 - Z1 & Z4 - X1\end{matrix} ] \cdot \\ {[ \begin{matrix}B2 - B1 & B3 - B1 & B4 - B1 \\ T2 - T1 & T3 - T1 & T4 - T1 \\ F2 - F1 & F3 - F1 & F4 - F1\end{matrix} ]}^{- 1} [ \begin{matrix}B - B1 \\ T - T1 \\ F - F1\end{matrix} ] + [ \begin{matrix}X1 \\ Y1 \\ Z1\end{matrix} ]\end{matrix}$$

To determine the closest polyhedron for use in such an extrapolation, the linear distance between the newly measured BTF point and each set of BTF points in the lookup table can be calculated by determining the magnitude of the difference between the new point and the various lookup table points. Then, the polyhedron for the point in the lookup table having the shortest distance can be selected and used in the above-referenced extrapolation equation. In addition and/or alternatively to the extrapolation and interpolation algorithms discussed, other regression calculations, curve-fitting equations, and mathematically formulae may be utilized.

As can be understood, steps 420 and 422 of FIG. 4b can be conducted for each pixel in the image data to convert all of the image data to a standard color space. As noted above, multiple copies of the image data may exist, if scans were taken of the image at varying development times. In this case, a separate lookup table could be utilized to convert each copy separately to standard color spaces, and then the various converted copies stitched into a single digital image. Alternatively, the separate copies can be stitched into a single digital image and then one lookup table utilized for converting the data to the standard color space.

After the set of standard color space values has been interpolated for the image pixel data using the polyhedron chosen for each pixel, then additional image processing operations and/or corrections may be conducted on the image data in the standard color space. Color correction, illumination correction, artifact correction, linearization, grey scale correction and sharpening are examples of some of the image processing steps which may be conducted on the image data, while it is in either the standard color space, or some other color space.

Once the desired image processing has been conducted and the image data is in the standard color space, the data may be converted to a device-dependent color space, as shown at block 424 of FIG. 4b. The device-dependent color space chosen will depend upon the type of device with which the image will be viewed. For example, to display the image on a monitor, the image data may be converted from the standard color space to the RGB color space. To print the image on a printer, the image data may be converted from the standard color space to the CMY or CMYK color space. Methods and algorithms for transforming between standard color spaces, such as the XYZ color space, and other color spaces are disclosed in “A Technical Introduction to Digital Video” by Charles A. Poynton.

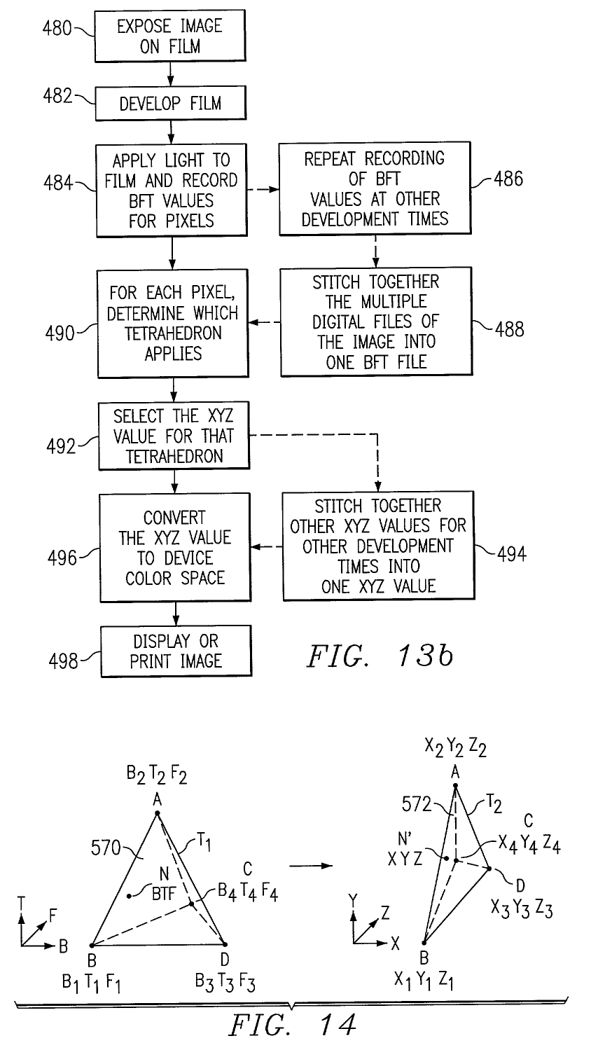

An alternative method of developing a color conversion lookup table for a digital film development system is illustrated in FIG. 13a, and a method of using such a lookup table is illustrated in FIG. 13b. Referring to FIG. 13a, color samples, chips, or patches are created or obtained at step 450. The XYZ color space coordinates for the samples are determined (or obtained) at step 452, and the samples are exposed onto film at step 454 (if they are not already on film). The film is then developed, during step 456, such as by using a chemical developer or substance. During development of the film, radiation, such as infrared light, is applied to the front of the film, and, at an earlier or later instance in time, to the back of the film. This step is shown at block 458 of FIG. 13a. The radiation which is reflected off of the front of the film is then recorded, as is the radiation which is reflected off of the back of the film, as shown at block 460. In addition, radiation transmitted through the film is also recorded, as shown at block 462, during a separate application of radiation, during the step of applying radiation to the front of the film, or during the step of applying radiation to the back of the film. Thus, after steps 460 and 462, one or more sets of BTF values are obtained which represents each patch on the film. If multiple sets of BTF values are obtained for the same patch, they can be averaged together or otherwise mathematically combined.

Steps 464 and 466 may be conducted if it is desired to obtain digital data of the same color patch at other film developments times. In particular, as discussed above, steps 458, 460, and 462 can be repeated at a long film development time and/or at a short film development time, to obtain additional BTF files which represent the color patch. The multiple BTF files can then be stitched together to form a single enhanced file or set of BTF values for the color patch, as shown at block 466.

Once a set of BTF values is obtained for each patch on the film, a lookup table can be established which correlates the BTF values for each patch to the XYZ values for each patch (which were measured or obtained at step 452). Once the lookup table is established, groupings can be made of four neighboring points in the data to divide the data into multiple tetrahedrons, as discussed above. This step is shown as block 470. A single XYZ value can then be established for each tetrahedron. For example, the average of the XYZ values for the four points of the tetrahedron can be calculated. A large number of datapoints can be taken resulting in a large number of tetrahedrons and a high lookup table resolution, such that the value established for each tetrahedron has increased accuracy. This step is shown at block 472. The tetrahedron and its corresponding single XYZ value can then be stored in a table, such as shown in FIG. 16, which identifies a number of tetrahedrons (T1 through Tn) and maps each tetrahedron to a single set of XYZ values.

Once the lookup table of FIG. 16 is established, or calibrated, such as by using the method of FIG. 13a, then it can be utilized during image processing of other image data obtained by a digital film development system. For example, as shown in FIG. 13b, an image of a scene, person, and/or object is exposed on film, such as by using a camera. This is shown as block 480 of FIG. 13b. The film is then developed, at block 482, and radiation is applied to the film to record BTF values for the various small areas (pixels) which make up the image on the film. As noted above, multiple BTF files can be created for the image at other film development times and the multiple files stitched together to form a single BTF file for the image, as shown at steps 486 and 488.

Then, for each pixel in the image file having a set of BTF values, it is determined within which tetrahedron the pixel lies, such as by using the methods discussed above of comparing the location (with respect to the faces of the tetrahedron) of the BTF pixel value to the mean BTF value for the tetrahedron. This step is shown at block 490. Once the tetrahedron is determined, an XYZ value for that tetrahedron can be selected by consulting the lookup table, as shown at block 492. This XYZ value will be used for the pixel. If separate lookup tables are established for the various film development times during which digital images are created, then steps 490 and 492 can be repeated for the pixel data from the other digital image files. Thus, separate XYZ values may be selected for each pixel to represent the separate film development times. These separate XYZ values can then be stitched together, as shown at step 494 to form a single XYZ value for the pixel. Steps 490 and 492 can be conducted on each pixel which makes up the digital image file(s).

Once steps 490 and 492 are completed (and 494, if multiple tables are created for multiple film development times), a single digital image file exists for the image on the film and this file has a plurality of pixels, each pixel having an XYZ value which was determined by using one or more lookup tables. The sets of XYZ values which make up the file can then be converted to a device-dependent color space, such as the CMYK or the RGB color space, as shown at block 496. The resulting CMYK or RGB data can then be printed or displayed, as shown at block 498.

FIG. 15 illustrates an exemplary hardware embodiment of a color conversion system made according to principles of the present invention. In this embodiment, pixel sensors 600 detect infrared light reflected from the back of a developing film and pixel sensors 602 detect infrared light reflected from the front of the developing film. In addition, sensor 600 and/or sensor 602 detects light transmitted through the developing film from the other side of the film. The sensors may be charged coupled devices (CCD's) or other suitable detector of infrared light. An analog-to-digital convertor (ADC) 604 converts the magnitude of the sensed back, through, and front infrared light to digital BTF values for each pixel.

An image transformation and correction circuit 606 then receives the BTF values for each pixel and addresses a lookup table 608 to determine appropriate XYZ coefficients or values for the pixel. In particular, the circuit 606 determines in which polyhedron of data the BTF values lie. Based upon the polyhedron selected, the circuit 606 addresses the lookup table 608 to select the corresponding XYZ coefficients or values for that polyhedron. For each pixel, the circuit 606 may repeat the process of selecting a polyhedron and addressing the lookup table 608 to determine corresponding XYZ values. Accordingly, the BTF image data is converted to corresponding XYZ image data.

To print the XYZ image data on a monitor 612, the XYZ image data can be converted to an RGB color space, using a suitable transformation method. To print the image data on a printer 614, the XYZ image data can be converted to a CMY or CMYK color space, using a suitable transformation method. A color space convertor circuit 610 may be utilized for this purpose. The circuit 610 may be integral with the circuit 606 or may be separate and/or remote. The circuits 610 and 606 may comprise processors, controllers, logic circuitry, programmable circuitry or other suitable hardware devices.

The various exemplary methods and systems described above can be implemented in a number of ways, such as by providing a set of software instructions on a computer readable medium, or by providing a programmable apparatus having executable instructions suitable for carrying out steps stored in a RAM, a ROM, and/or other memory units. Also, any of a variety of suitable circuitry, digital computers, processors, and/or controllers can be utilized.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. Moreover, although a variety of potential configurations and components have been described, it should be understood that a number of other configurations and components could be utilized without departing from the scope of the invention.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

What is claimed is:

1. A method for converting image data in a digital film development system, the method comprising:
developing a film medium having an image exposed thereon;
applying radiation to the front of the developing film medium;
sensing radiation reflected from the front of the developing film medium to create a front value;
applying radiation to the back of the developing film medium;
sensing radiation reflected from the back of the developing film to create a back value;
sensing radiation transmitted through the developing film to create a through value;
creating a lookup table having datapoints correlating back, through, and front values to standard color space values;
matching the back value, front value, and through value to a polyhedron formed from the datapoints in the lookup table; and
determining a set of standard color space values which correspond to the back value, front value, and through value by using the datapoints corresponding to the selected polyhedron.

2. The method as recited in claim 1, wherein the polyhedron is a tetrahedron formed by four datapoints in the lookup table.

3. The method as recited in claim 1, wherein the standard color space is the XYZ color space.

4. The method as recited in claim 1, wherein the datapoints are evenly spaced in the lookup table.

5. The method as recited in claim 1, wherein each datapoint corresponds to a color patch.

6. The method as recited in claim 5, wherein each color patch corresponds to a color calibration patch exposed on film, each patch having known standard color space values and measured back, through, and front values.

7. The method as recited in claim 1, wherein at least one datapoint in the lookup table is predicted using a synthesized spectral power density for a color.

8. The method as recited in claim 1, further comprising:
converting the set of standard color space values to a device-dependent color space.

9. The method as recited in claim 1, wherein the device-dependent color space is the RGB color space.

10. The method as recited in claim 1, wherein the back value, through value, and front value are created by stitching together sensed radiation measurements from a plurality of film development times.

11. The method as recited in claim 1, wherein the determining step comprises:
interpolating a set of standard color space values using the datapoint corresponding to the polyhedron.

12. The method as recited in claim 1, wherein the determining step comprises:
extrapolating a set of standard color space values using the datapoints corresponding to the polyhedron.

13. A system for converting data between color spaces, the system comprising:
a digital film development system adapted to create a set of back, through, and front digital values from an image developing on a film medium, the back value corresponding to radiation reflected from the back of the developing film medium, the through value corresponding to radiation transmitted through the developing film medium, and the front value corresponding to radiation reflected from the front of the developing medium;
a memory unit storing a lookup table having datapoints correlating back, through, and front values to standard color space values; and
a color space conversion circuit in communication with the digital film development system and the memory unit and configured to receive the set of back, through, and front digital values, to match the set to a polyhedron formed from the datapoints in the lookup table, and to determine a set of standard color space values using the polyhedron.

14. The system as recited in claim 13, wherein the color space conversion circuit comprises at least one microprocessor.

15. The system as recited in claim 13, wherein the standard color space values comprise XYZ color space values.

16. A lookup table correlating digital film development system data to standard color space values, the lookup table comprising
a set of back, through, and front values corresponding to radiation reflected from the back of a color patch on a developing film strip, radiation transmitted through the color patch on the developing film strip, and radiation reflected from the front of the color patch on the developing film strip; and
a set of standard color space values corresponding to the color patch, wherein the set of standard color space values are correlated to the set of back, through, and front values.

17. The lookup table as recited in claim 16, wherein the set of standard color space values comprises coefficients for use in converting the set of back, front, and through values to standard color space values.

18. A method for developing a lookup table for use in converting digital image data from a digital film development system to a standard color space, the method comprising:
developing a film medium having at least one color patch exposed thereon;
applying radiation to the front of the developing film;
sensing radiation reflected from the front of the developing film to create a front data value;
applying radiation to the back of the developing film;
sensing radiation reflected from the back of the developing film to create a back data value;
sensing radiation transmitted through the developing film to create a through data value;
in a lookup table, mapping the back, through, and front values to standard color space values for the color patch; and
determining a plurality of polyhedrons defined by the values in the lookup table.

19. The method as recited in claim 18, wherein the standard color space values comprise XYZ color space values.

20. The method as recited in claim 18, further comprising:
obtaining a set of back, front, and through values from an image on developing film;
selecting a polyhedron which corresponds with the set of back, front, and through values; and
using the polyhedron to select a corresponding set of standard color space values for the set of back, front and through values.
